(19) United States
(12) Patent Application Publication
(10) Pub. No.: US 2008/0189473 A1
(43) Pub. Date: Aug. 7, 2008

(54) MLC SELECTED MULTI-PROGRAM FOR SYSTEM MANAGEMENT

(75) Inventor: Michael Murray, Mountain View, CA (US)

Correspondence Address: SCHWEGMAN, LUNDBERG & WOESSNER, P.A., P.O. BOX 2938, MINNEAPOLIS, MN, 55402, US

(73) Assignee: MICRON TECHNOLOGY, INC

(21) Appl. No.: 11/672,076

(22) Filed: Feb. 7, 2007

(51) Int. Cl. G06F 12/02

(52) U.S. Cl. 711/103; 711/171; 711/E12.002; 711/E12.008

(57) ABSTRACT

Methods, apparatus, and systems may operate to utilize at least one of a single level cell structured or a multi-level cell structured non-volatile memory device organized as a plurality of data blocks, including at least one full page block having one or more full pages comprising a plurality of contiguous sectors. Further activities may include utilizing page blocks that include status indicators to determine the validity of data contained within selected pages. Additional activities may include checking the associated status indicator prior to transferring information to and from the selected page.

### TECHNICAL FIELD

Embodiments disclosed herein relate generally to memory devices, including non-volatile memory devices.

### BACKGROUND

Memory often takes the form of semiconductor integrated circuits in computers and other electronic devices. There are many different types, including random-access memory (RAM), read-only memory (ROM), dynamic random access memory (DRAM), synchronous dynamic random access memory (SDRAM), and flash memory.

Flash memory devices may utilize one-transistor memory cells allowing for high memory density, high reliability and low power consumption. Flash memory devices are most commonly made in two forms: NOR flash and NAND flash. NAND flash includes single-level cell (SLC) and multi-level cell (MLC) architectures. These memory devices can be categorized further, as volatile or non-volatile. Volatile memory devices require power to maintain data, while non volatile memories are capable of maintaining data in the absence of a power supply. An example of a non-volatile memory is a flash memory that stores information in a semiconductor circuit without the need for power to maintain the information over time.

While SLC memory permits storing data as a single bit in either of two states, MLC memory allows for higher density because it allows storage of two or more data bits in each memory cell. Memory devices, whether SLC or MLC, can be organized or configured into blocks that are divided up into pages having smaller segments, referred to as sectors. Each sector is able to store bits of information; the number of bits may be determined by the density of the memory device. Each block may include a flash data program that directs the process of filling sectors with data and for selectively invalidating cells within a sector that are no longer needed (e.g., data cells within a sector of memory that have already been transferred out and are no longer needed for storage). The length of this flash data program affects the performance of the memory device and therefore it may be desirable to shorten the flash data program, or optimize its use. Thus, reducing data transfer times may increase reliability, and reduce performance losses.

### BRIEF DESCRIPTION OF THE DRAWINGS

FIG. 1 is a block diagram of a memory system, according to various embodiments of the invention.

FIG. 2 is a three-dimensional block diagram showing the organization of arrays of memory cells in a NAND flash memory, according to various embodiments of the invention.

FIG. 3 is a schematic diagram of a NAND flash memory array, according to various embodiments of the present invention.

FIG. 4 is a diagram showing the distribution of threshold voltages of an MLC array of FIG. 3, according to various embodiments of the present invention.

FIG. 5 is a block diagram of a second program operation on a lower page to set a status indicator for data validity, according to various embodiments of the present invention.

FIG. 6 is a flow chart of a method for invalidating information on a particular page using MLC flash devices, according to various embodiments of the invention.

FIG. 7 is a flow chart of a method for assigning a status indicator on a particular page, within a page block, using MLC flash devices, according to various embodiments of the invention.

FIG. 8 is a block diagram of a system according to various embodiments of the invention.

### DETAILED DESCRIPTION

Some of the disclosed embodiments provide a mechanism for invalidating information on a selected page using MLC flash devices in preparation for filling memory blocks. In an embodiment, a memory allocation request is received from a processor configured to manage multi-level non-volatile memory devices organized as a plurality of blocks, each block including multiple sectors organized within a page, and each sector organized to store a plurality of data bits until the page block is full. According to various embodiments, each of the multiple sectors may be selectively programmable, selectively erasable, and uniquely addressable.

Page caching provides a way to fill a full page with data, wherein a page program directs the data filling operation. In the event that data sectors are no longer needed, they may be identified by the processor as “invalidated,” which reduces the amount of time required to search for “valid” data sectors during subsequent allocation requests, avoiding excess processing time. One method to accomplish this is to provide a second page program directed to a portion of a page which may program a flag or status indicator to indicate that data contained in the page portion is “invalid.” This method may quickly identify valid sectors of data within a given page without increasing page block program and erase cycle time.

There are two types of data blocks, full page and partial page. A full page block contains a full page of contiguous sectors of data designed to be written to as a full page in a single operation. If there is less data available than will fill the full page block during a single allocation request, the full page block remains partially filled until the data is removed, leaving unused space. The full page block also contains block information in a spare location of each written page for block identification, the block information being the same for each written page within that block.

A partial page block contains at least one partial page of data that is assigned to one of the full page blocks. Data may be written to a single partial page in multiple operations requiring varying data sizes. The partial page block contains unique logical sector address information which may be in the last sector of each partially written page. The logical sector address range may be restricted to the logical sector range of one of the partially filled full page blocks.

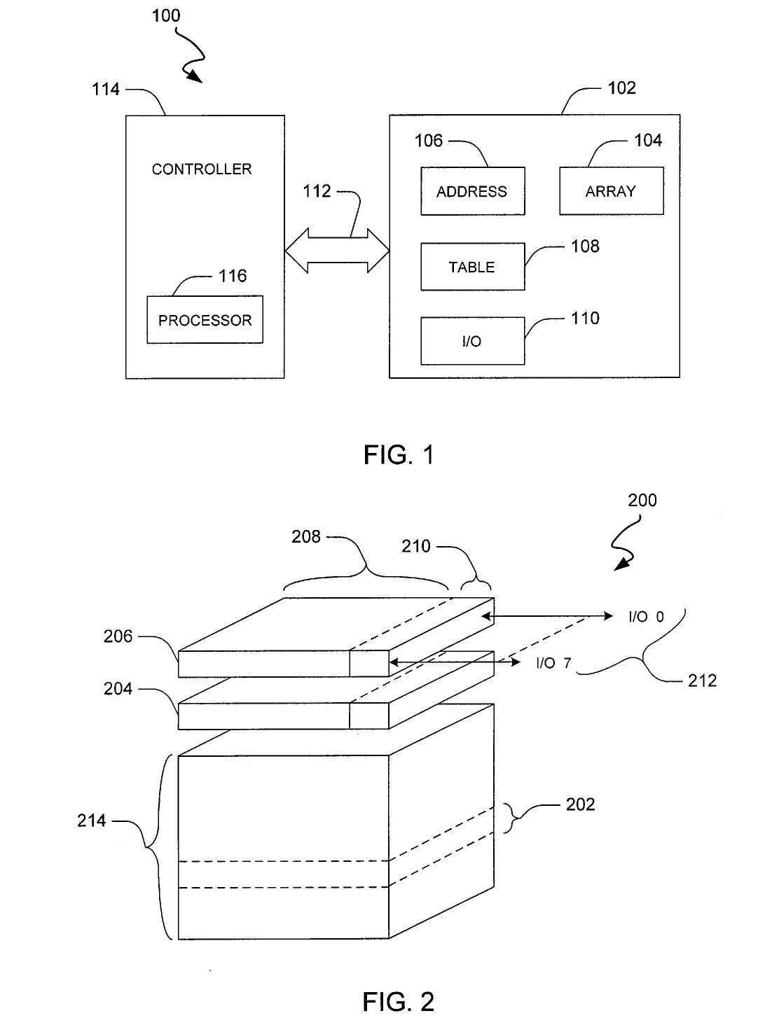

FIG. 1 is a simplified block diagram of a memory system 100 according to various embodiments of the present invention. In various embodiments, memory system 100 includes an integrated circuit 102 comprising an array 104 of non-volatile floating gate memory cells. The integrated circuit 102 may be configured to include a look up table 108, such as a page table and/or sector count table to track available pages or sectors, address circuitry 106, and input/output (I/O) circuitry 110. The look up table 108 may be maintained in a separate set of storage locations, such as a random access memory (RAM) in the integrated circuit 102, or in some other location, such as in the controller 114. Memory array 104 may sometimes be referred to as flash memory when blocks of the memory array 104 may be erased concurrently, in a flash operation.

The memory system 100 may include a memory controller 114, which in turn may include a processor 116. The processor 116 may utilize control lines 112 to communicate with the memory array 104 via integrated circuit 102. Access to the memory array 104 may include one or more targeted or specified memory cells linked by addressing via the control lines 112. When access to one or more memory cells contained within the memory array 104 is established by the processor 116, data may be written to or read from the memory cells. When an allocation request associated with a read request is sent by the processor 116, such an operation may include accessing multiple rows or pages of data to allow identification of related data contained within the memory array 104. The memory controller 104 and/or processor 116 may be used to maintain the lookup table 108. According to various embodiments, the lookup table 108 may comprise more than one table, such as a first lookup table organized as a page table to store address information for available pages within a page block (or a group of sectors corresponding to the available pages), and a second lookup table organized as a sector count table to store the number of written sectors within a page.

FIG. 2 is a three-dimensional block diagram showing the organization of arrays of memory cells in a NAND flash memory 200, according to various embodiments of the present invention. Memory 200 may include one or more blocks 202, which may be representative of a portion of memory (e.g., a plurality of memory cells) in an array similar to memory array 104. The memory 200 may further include a data register 204, a cache register 206, a data area 208, a spare area 210, I/O ports 212 and a plane 214. Data is transferred to and from the NAND flash memory 200, byte by byte through the data register 204 and the cache register 206. The cache register 206 may be located adjacent to I/O control circuitry, such as I/O circuitry 110 shown in FIG. 1, and may act as a data buffer for the data moved in and out of the memory 200 via the I/O ports 212.

The data register 204 may be located adjacent to a memory array, such as the memory array 104, and may act as a data buffer for the NAND flash memory array operation. In various embodiments, the length of data area 208 and spare area 210 is defined as a “page”. In some instances, NAND flash memory is programmed and read in page-based operations and is erased in block-based operations. In some cases, during page read and write operations, the data register 204 and cache register 206 are coupled together and act as a single register. In some cases, during cache operations, the data register 204 and cache register 206 operate independently to increase data throughput.

The NAND flash memory shown in FIG. 2 may be configured as blocks 202 of pages. Each block 202 usually comprises 16, 32, or 64 pages. In various embodiments, each page may comprise 512 bytes (256 words) in data area 208 with an extra 16 bytes (8 words) in spare area 210. In various embodiments, each page may have 2048 bytes (1024 words) in data area 208 and 64 bytes (32 words) in spare area 210. Spare area 210 may be used to store bits used for marking invalid blocks during the manufacturing process. Additionally, spare area 210 may store logical address information used to reference partial page cache entries associated with multiple full page blocks. The example of FIG. 2 shows the I/O ports 212 as having a range of zero to seven bits (or 8 bits total) but this can vary as described with respect to page sizes above.

In various embodiments of MLC NAND flash memory, a whole page can be programmed at the same time. An allocation request associated with a read or write operation to transfer information may occur on a page basis (e.g., 528 bytes at a time, as opposed to a byte or word basis that is performed in a NOR flash.) Additionally, the erase operation may occur on a block basis. In the operation of some embodiments, during a page read operation in various embodiments, a page of 528 bytes is transferred from memory into the data register 204. In a page write operation, a page of 528 bytes is written into the data register 204 and then programmed into the memory array 104, such as within the space comprising data area 208. Also, in a block erase operation, a group of consecutive pages may be erased in a single operation.

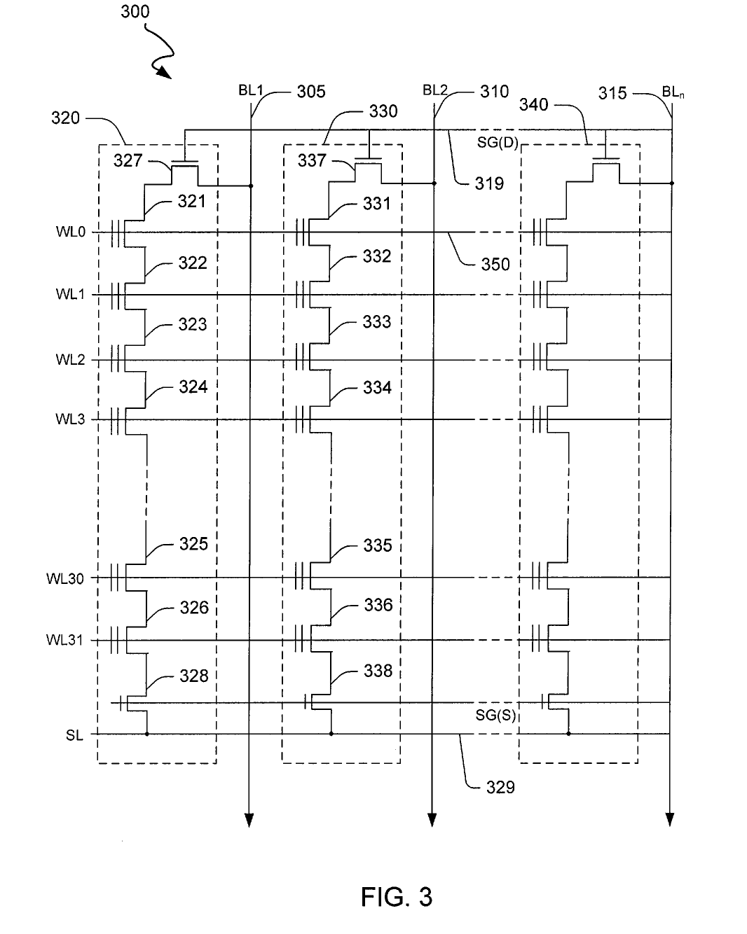

FIG. 3 is a schematic diagram of a NAND flash memory array 300, according to various embodiments of the present invention. The memory array 300, which may be similar to or identical to memory array 104 in FIG. 1, is shown with a number of bit lines BL1, BL2-BLₙ, and the quantity used may depend upon the memory density of the array 300. The memory array 300 comprises floating gate memory cells 321-326 arranged in series string 320. Each of the floating gate memory cells 321-326 is connected drain to source, in series, such that the drain of the first floating gate memory cell 321 couples to first bit-line BL1 through first drain select gate 327. The state of the first drain select gate 327 is controlled by drain select gate control line SG(D) 319. The arrangement of the series string 320 includes coupling the last floating gate memory cell 326 to the first bit-line BL1 through first source select gate 328, and is controlled by source select gate control line SG(S) 329.

A similar arrangement occurs in the second series string 330 and final series string 340 such that the final series string 340 may determine the memory density of the array. As such, similar elements (e.g., series strings, floating gate memory cells, etc.) are labeled in a similar manner. The second series string 330 includes floating gate memory cells 331-336, connected drain to source, having the first drain memory cell 331 coupled to second bit-line BL2 through second drain select gate 337, and is controlled by drain select gate control line SG(D) 319. The last memory cell 336 of the second series string 330 couples to the second bit-line BL2 through second source select gate 338, and is controlled by source select gate control line SG(S) 329. As is the case with each of the cells 321-326 in string 320, the cells 331-336 in string 330, and all cells in string 340 may comprise either SLCs or MLCs.

Word-lines WL0-WL31 that span multiple series strings 320, 330 and 340 are coupled to the control gates of every floating gate memory cell in a row in order to control their operation. For example, as shown in FIG. 3, the first word line WL0 350 couples to each first floating gate memory cell 321, 331 and 341 of bit-lines BL1, BL2 and BLₙ. Each bit-line BL1-BLₙ eventually couples to sense amplifiers (not shown) that detect the state of each cell. In operation, word-lines WL0-WL31 select the individual floating gate memory cells in the series strings 320, 330 and 340 to be written to or read from and operate the remaining floating gate memory cells in each series string 320, 330 and 340 in a pass-through mode.

Each floating gate memory cell can be programmed as a single bit per cell or as multiple bits per cell. In some embodiments the SLC and MLC memory cells have the same structure, in other embodiments there may be different physical structures. As such, as referred to herein, an SLC structure allows programming a single bit per cell, and an MLC structure permits programming multiple bits per cell, even if the physical structures are the same. Each floating gate memory cell's threshold voltage (Vₜ) determines the data that is stored in the cell. For example, in a single bit per cell architecture, a Vₜ of 1V might indicate a programmed cell, while a Vₜ of −1V might indicate an erased cell.

The MLC architecture has more than two Vₜ windows per cell that each indicate a different storage state. Multi-level floating gate memory cells take advantage of the analog nature of a traditional flash cell by assigning a bit pattern to a specific voltage range stored on the cell. This technology permits the storage of two or more bits per cell, depending on the quantity of voltage ranges assigned to the cell. In certain embodiments, a floating gate memory cell may be assigned four different voltage Vₜ distributions having a width of approximately 200 millivolts (mV). In various embodiments, a separation of 0.3V to 0.5V is assigned between each Vₜ distribution range as well. Reductions in this separation zone between the Vₜ distributions may increase the chance that the multiple Vₜ distributions overlap, which can lead to logic errors.

Programming selected floating gate memory cells within a selected word-line (WL) may be accomplished by sinking the bit-line (BL) to 0V. This results in a potential formed across the channel, and the WL will cause the floating gate memory cell to be programmed. The Vₜ will increase as higher voltage programming pulses are applied. Between each programming pulse, a verification phase is performed in which the selected WL is lowered to 0V, the unselected WLs are lowered to 5V and the state of the selected WL is detected. If the floating gate memory cell contains a Vₜ sufficient to prevent conduction of the device with 0V on the WL, it is deemed to be programmed, otherwise it is deemed to be still erased and programming pulse height is increased (e.g., by 0.5V) and again applied to the selected WL. This process is repeated until all selected WLs are detected as being programmed.

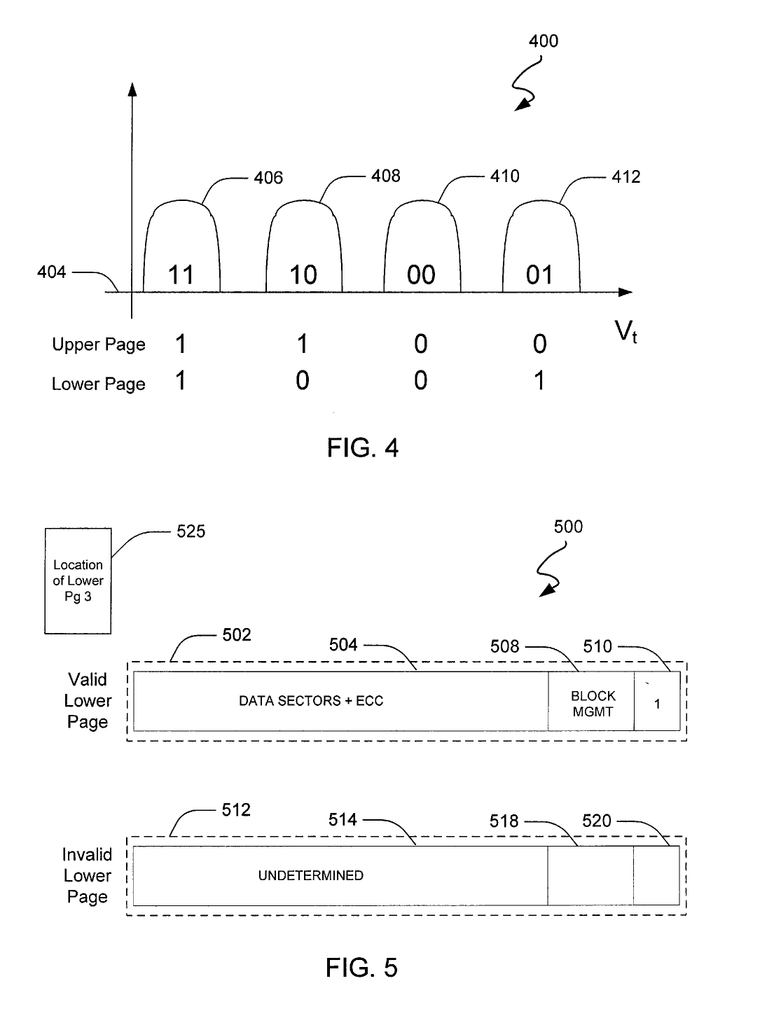

FIG. 4 is a diagram showing the distribution of threshold voltages of an MLC array of FIG. 3, according to various embodiments of the present invention. The X-axis 404 represents threshold voltages (Vₜ ) from lowest threshold 406 to highest threshold 412. In certain examples, programming begins with the highest threshold 412 performed first on the associated WL in decreasing order of threshold voltages, as the lowest threshold 406 represents an erased state. The erased state, or lowest threshold 406, indicates a logical “11” since both bits of the multi-level cell are in a “1” state when erased. It should be noted that, alternatively, some memory devices may indicate an erased state with a logical “0” on each bit. In certain examples, the highest threshold 412 is the first programmed threshold. This places the highest voltage on the WL prior to all lower multi-level distributions being programmed, which reduces the chance of disturbing conditions within other cells on the same WL that are to be programmed at lower Vₜ distributions.

In some embodiments, all of the cells in a page to be programmed with bits having the highest threshold 412 are programmed first. The next highest threshold 410 may be programmed next, followed by the next to lowest threshold 408, and then the lowest threshold 406. These programming operations may be accomplished with consecutive programming and verification pulses where two verification pulses with two different levels are applied (i.e., 2V for “01,” and 1.3V for “00”) between every increasing programming pulse. This procedure may repeat for each data bit within each sector of a page when attempting to fill a data block with data.

According to various embodiments of the present invention, programming techniques may be restricted to a single program per page. One method of determining whether a page contains data no longer needed (e.g., data that has already been copied out of the cache into its destination memory location) is to mark it as invalid. As a result, a copy of the data may remain within cache until further action is taken to utilize the space for subsequent operations. Cache memory and destination memory may be similar to or identical to flash memory having the structure shown in FIGS. 1-4. Indicating invalidity may be accomplished by filling sectors of a page with logic zeros, or by keeping a separate non-volatile list in random access memory (RAM) of invalid pages within which to search. However, due to the MLC configuration of some memory devices, it may become complex and time-consuming to fill sectors of each page of memory with zeros each time a data transfer is completed.

This difficulty may be addressed by using a second program per page that is implemented in a limited manner. According to various embodiments, the application that programs block management data may be used for identifying invalidity. Block management data can include program information within a given page that correlates a logical block of memory with a physical block of memory. In various embodiments, one or more bits stored in a particular page may be reserved or assigned to indicate (e.g., as a flag or status indicator) the validity of the information contained within the page. Reserving/assigning one or more bits to be used as a status indicator can include assigning bits to accompany the block management information and/or data contained within the upper or lower page of a multi-level cell memory device. According to various embodiments, a single page may comprise an upper page portion and a lower page portion. A lower page portion may be used to store the least significant bits of the page and the upper page portion may be used to store the most significant bits. Either the upper or the lower page portions may be used first in an operation related to a read or write allocation request. According to some embodiments, assigning an upper page portion may be disallowed until the lower page portion is first utilized. The memory device may be configured to transfer a second part of the data to the upper page portion after transferring a first part of the data to the lower page portion.

FIG. 5 is a block diagram of a second program operation to set a status indicator for data validity on a lower page, according to various embodiments of the present invention. The block diagram 500, according to various embodiments of the present invention, represents an allocation request associated with a write request or a read request which includes a valid lower page portion 502 and an invalid lower page portion 512. The number of sectors which make up a full page may vary from system to system and a multi-level memory cell may include both an upper page portion and a lower page portion, either of which may contain block management information and a validity status indicator. It should also be noted that the number of pages within a full page block can vary from system to system.

The valid lower page portion 502 comprises sectors 504 of data and may include error correction code (ECC), newly added block management information 508 and a data validity flag or status indicator 510. The data status indicator 510 may be a logical “1” upon the completion of a prior erase cycle (e.g., during an erase cycle all bits may be set to a logic “1”). A data status indicator 510 may remain in a logic “1” state to indicate that the information contained within the page is valid, such as during one or more allocation requests. A valid state may indicate that one or more of the sectors 504 have recently been filled with information associated with a read operation, or that one or more of the sectors 504 are empty and are ready to be filled with information associated with a write operation. The number of bits used for the status indicator 510 may include one or more bits reserved within an upper or a lower page and the state of the bits may vary. For simplicity, the block diagram 500 illustrates a single bit for the status indicator 510 contained within a lower page portion. The status indicator 510 may be set to a logical “0” to indicate that the information contained within the page is invalid or not determinable. An example in which the data is determined to be invalid is when the information contained within the sectors has been copied from the cache to a physical memory location, such that a copy of the data remains within cache but is no longer needed. On subsequent allocation requests, the status indicator 510 may be checked when searching for available space in order to determine if the information contained within the lower page portion 502 is reliable. This method reduces access time and eliminates the need to either empty the data sectors, set them to a known logical state, or search through a lookup table.

The invalid lower page potion 512 comprises undetermined data block 514, undetermined block management information 518, and reserved flag or status indicator bits 520. This state of invalidity may exist when the page program determines that a page needs to be released to free up space for future memory allocation. This can occur due to too many unfilled pages which are only partially filled with data or the data contained within that page is old (e.g., has been held for a long period of time). The page program may include instructions to cycle through the available memory space, efficiently allocating space and eliminating partially filled pages by shifting data from one page to another.

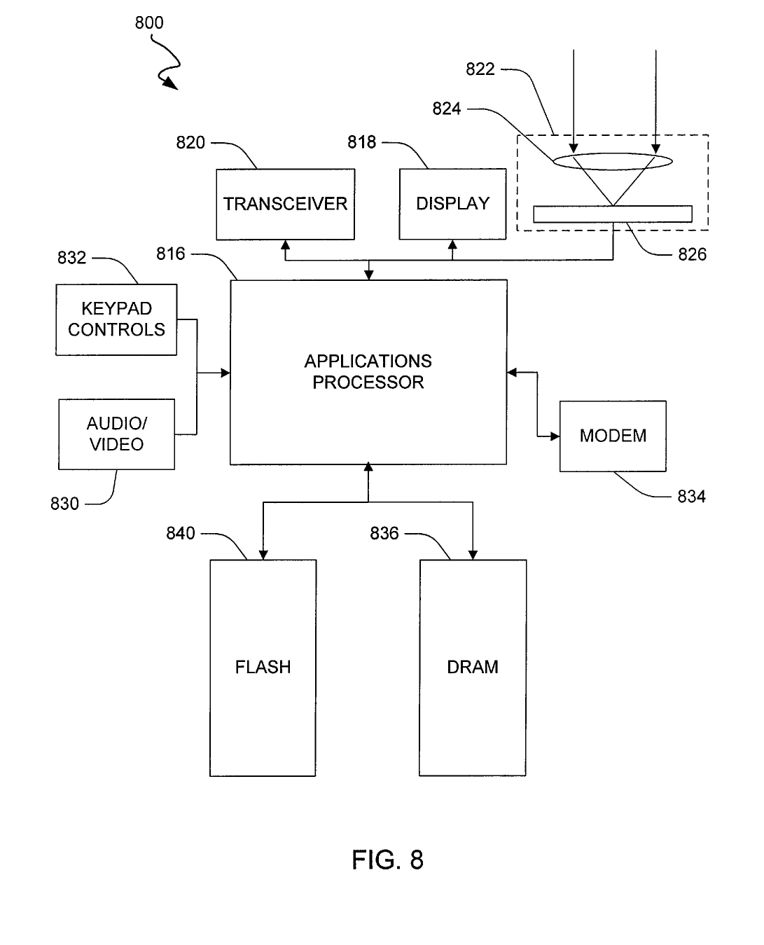

In various embodiments, the status indicator bits 520 may be checked upon entering the next, or any subsequent power cycle of the processor. A sector count table 525, also called a lookup table, may be used to store the location of the next valid lower page portion 502 within a page block. The sector count table 525 may reside within a portion of a dedicated memory such as DRAM (e.g., see elements 108 of FIG. 1, and 836 of FIG. 8), located separate from the flash memory as part of a system, and effectively makes the page available for future use; but when using a status indicator 510, it may be unnecessary to empty the data sectors, or alternatively to fill the sectors with a logical “1,” to indicate this state.

An example in which data is cached or merged includes a write request that initiates checking the starting request sector of a full page block for an offset within the starting page (e.g., the first empty sector is not the first sector in the page). An offset can be an indication that data is already written in the first part of the page. If an offset exists, the write request then begins searching from the beginning of the page boundary for preceding sectors (e.g., sectors associated with the current write request intended to reach the same destination in memory). If no preceding sectors are present, the write request may be a non-sequential write request, or the first of a new sequence. Next, a look up table may be used to store valid entry address information. If a valid entry exists, the write request may prompt writing the current partial page data into this previously written full page block. If the remaining sectors of this previously written full page block will not provide sufficient space to hold the data associated with this write request, the write request may prompt writing the remaining sectors to a new page in the partial page block.

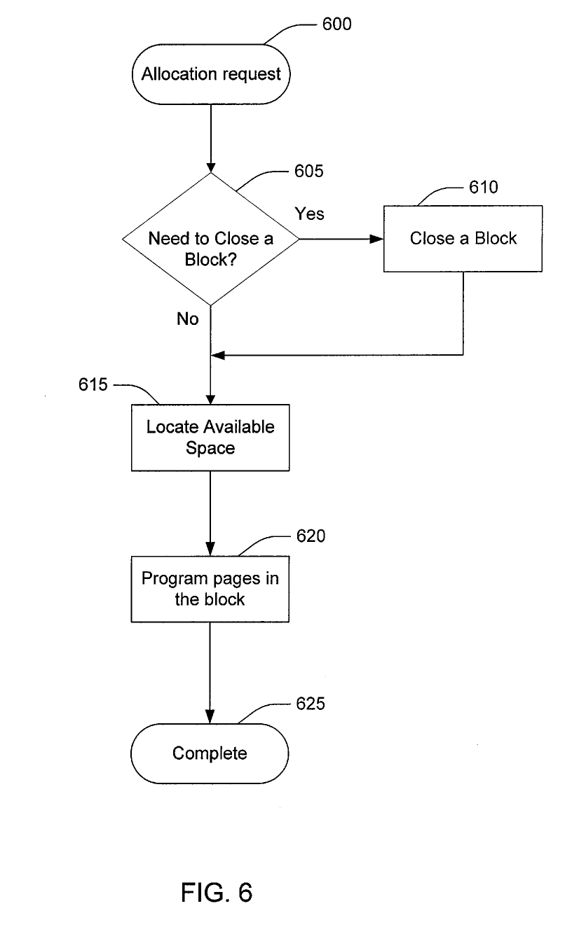

FIG. 6 is a flow chart of a method for invalidating information on a particular page, within a page block, using MLC flash devices, according to various embodiments of the invention. At 600, an allocation request associated with a write request is received from a processor. At 605, the processor determines if a block will be closed in order to make room for future allocation requests. For example, the processor may be accessing a number of unfilled blocks of pages and if the number of available blocks is exceeded, space may need to be made by shifting data among blocks, perhaps from a sector of one block to a sector of another block, and invalidating those blocks or sectors which are empty as a result. If, at 605, one or more blocks need to be closed, at 610, the processor selects the block to close. In various embodiments, the block selected to close comprises one which is mostly empty, one having the longest held data, or one having the most recently written information. Once selected for closure, the block may have its information shifted to another unfilled block of data. The validity status indicator for the selected block is then programmed as invalid, such as programming one or more bits to a logic “0.” If, at 605, there is no need to close, or, at 610, the selected block is closed, it is next determined, at 615, where to find available space within the block. This can be accomplished by utilizing a lookup table of invalid entries. The validity status indicators of current blocks can be used to find an invalid or available block. Once available space is found in a block which is invalid, the entire block is erased (e.g., all bits set to a logic “1”, including validity status indicator bits). At 620, the processor writes information to the available space, then, at 625, the process is completed.

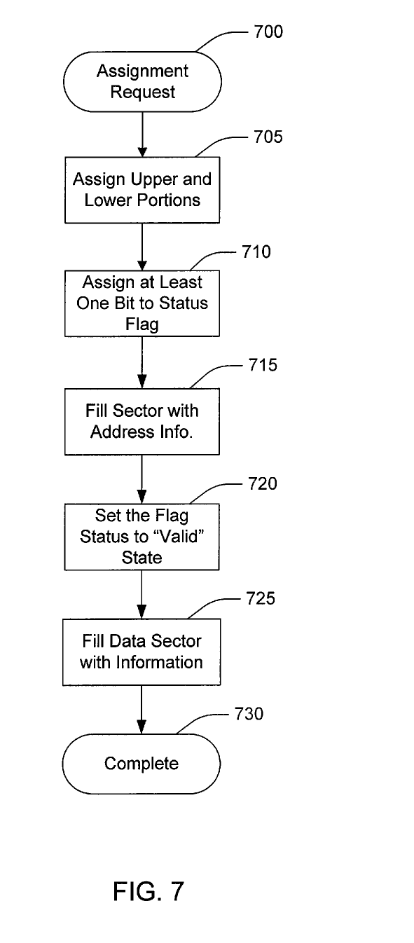

FIG. 7 is a flow chart of a method for assigning a status indicator on a particular page, within a page block, using MLC flash devices, according to various embodiments of the invention. At 700, an assignment request, such as a write request, is received from a processor. At 705, the page is divided by assignment into an upper page portion and a lower page portion. At 710, a storage location to store at least one bit is assigned to the flag, or status indicator, of the currently selected lower page portion. At 715, at least one sector is filled with address information to logically assign the physical memory within the page. Then, at 720, the status indicator, from 710 above, is set to a valid state (e.g., a logical “1” is stored in the storage location). At 725, the data sectors of the selected page are filled with information and, at 730, the process is completed.

FIG. 8 is a block diagram of a system 800 according to various embodiments of the invention. The system 800 may include one or more apparatus, which may be similar to or identical to that of memory system 100 in FIG. 1. The system 800, in some embodiments, may comprise a processor 816 coupled to a display 818 to display data processed by the processor 816 and/or a wireless transceiver 820 (e.g., a cellular telephone transceiver) to receive and transmit data processed by the processor.

The memory system(s) included in the apparatus 800 may include dynamic random access memory (DRAM) 836 and non-volatile flash memory 840 coupled to the processor 816. The flash memory 840 may be similar to or identical to flash memory having structure and operations shown in FIGS. 1-7, and described above. The DRAM 836 and the flash memory 840 may each be used to store data processed by the processor 816.

In various embodiments, the system 800 may comprise a camera 822, including a lens 824 and an imaging plane 826 coupled to the processor 816. The imaging plane 826 may be used to receive light rays 828 captured by the lens 824. Images captured by the lens 824 may be stored in the DRAM 836 and the flash memory 840.

Many variations of system 800 are possible. For example, in various embodiments, the system 800 may comprise an audio/video media player 830, including a set of media playback controls 832, coupled to the processor 816. In various embodiments, the system 800 may comprise a modem 834 coupled to the processor 816.

Although specific embodiments have been illustrated and described herein, it will be appreciated by those of ordinary skill in the art that any arrangement which is calculated to achieve the same purpose may be substituted for the specific embodiments shown. This application is intended to cover adaptations or variations of the present subject matter. It is to be understood that the above description is intended to be illustrative, and not restrictive. Combinations of the above embodiments, and other embodiments will be apparent to those of skill in the art upon reviewing the above description. The scope of the present subject matter should be determined with reference to the appended claims, along with the full scope of equivalents to which such claims are entitled.

The examples that are described in the above description provide sufficient detail to enable those skilled in the art to practice the inventive subject matter, and serve to illustrate how the inventive subject matter may be applied to various purposes or embodiments. References to “an”, “one”, or “various” embodiments in this disclosure are not necessarily to the same embodiment, and such references may contemplate more than one embodiment. Other embodiments may be utilized, and structural, logical, and electrical changes may be made without departing from the scope of the present disclosure. The terms “data” and “information” may be used interchangeably herein.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method, comprising:
receiving a memory allocation request from a processor to manage a memory array comprising at least one of a single level cell structure or a multi-level cell structure and organized as a plurality of blocks, each of the blocks comprising a group of sectors capable of storing a plurality of data bits;
assigning at least one page block from the plurality of blocks for memory storage, the at least one page block comprising at least one page;
assigning at least one status indicator to the at least one page, the status indicator to indicate validity status of data stored within the at least one page; and
storing the data within the group of sectors included in the at least one page.

2. The method of claim 1, comprising:
reading the at least one status indicator prior to storing the data.

3. The method of claim 2, wherein reading the at least one status indicator includes determining the data stored within the at least one page is invalid.

4. The method of claim 3, comprising:
checking the at least one status indicator upon a subsequent power cycle of the processor.

5. The method of claim 1, comprising:
erasing at least one sector from the group of sectors of at least one of the plurality of blocks upon receiving a memory allocation request associated with a write operation, wherein the at least one status indicator indicates invalid information is stored within the at least one page to which it is assigned.

6. The method of claim 1, comprising:
writing at least one address of the group of sectors to a first lookup table; and
referencing a second lookup table to determine a number of written sectors of the group of sectors within the at least one page.

7. The method of claim 1, wherein assigning at least one page block from the plurality of blocks includes assigning an upper page portion and a lower page portion as part of the at least one page.

8. The method of claim 7, wherein assigning an upper page portion is disallowed until the lower page portion is first utilized.

9. The method of claim 1, wherein assigning at least one status indicator to the at least one page comprises:
setting at least one bit of the at least one status indicator to a logical zero to indicate invalid status.

10. The method of claim 1, wherein reserving at least one status indicator to the at least one page comprises:
setting at least one bit of the at least one status indicator to a logical one to indicate valid status.

11. The method of claim 1, wherein the memory allocation request is associated with at least one write operation.

12. The method of claim 1, wherein the memory allocation request is associated with at least one read operation.

13. A method comprising:
managing access to a multi-level cell non-volatile memory device organized as a plurality of data blocks comprising at least one page block, the at least one page block comprising at least one page of a plurality of sectors, and at least one status indicator to indicate validity status of data stored within the at least one page, wherein managing access comprises:
assigning the at least one status indicator comprising a storage location for at least one bit to indicate the status of the at least one page;
storing an address in at least one sector of the plurality of sectors to logically associate the at least one sector with the at least one page; and
storing data within the at least one sector of the plurality of sectors associated with the at least one page.

14. The method of claim 13, comprising:
reading the at least one status indicator prior to storing the data within the at least one sector of the plurality of sectors.

15. The method of claim 13, wherein managing access comprises:
dividing the at least one page by assigning an upper page portion and a lower page portion.

16. The method of claim 15, wherein assigning an upper page portion is disallowed until the lower page portion is first utilized.

17. The method of claim 13, comprising:
checking the at least one status indicator upon a next power cycle of the processor.

18. The method of claim 13, comprising:
erasing at least one sector from the plurality of sectors of at least one of the plurality of data blocks upon receiving a memory allocation request associated with a write operation, wherein the status indicator indicates the data stored within the at least one page is invalid.

19. The method of claim 13, wherein assigning the at least one status indicator is associated with a write operation.

20. The method of claim 13, wherein assigning the at least one status indicator is associated with a read operation.

21. The method of claim 13, wherein assigning at least one status indicator comprises:
shifting data from the at least one sector of a first block of the plurality of blocks to the at least one sector of a second block of the plurality of blocks; and
programming the status indicator to indicate the data stored within the first block is invalid.

22. A method comprising:
managing access to a multi-level cell non-volatile memory device organized as a plurality of data blocks comprising at least one page block, the at least one page block comprising at least one page with a plurality of sectors and at least one status indicator to indicate validity status of data stored within the at least one page, wherein managing access comprises:
searching among the plurality of page blocks to identify a first page block having the status indicator indicating the data stored within the first page block is invalid; and
selecting the first page block to be used for storing data.

23. The method of claim 22, wherein selecting the first page block includes erasing at least one sector of the first page block and storing data within the at least one sector.

24. The method of claim 23, wherein erasing the at least one sector includes programming the at least one status indicator to indicate the data stored within the first page block is valid.

25. The method of claim 23, wherein erasing the at least one sector includes storing an address in the at least one sector to logically associate the at least one sector with the at least one page block.

26. An apparatus, comprising:
a multi-level non-volatile memory device organized as a plurality of data blocks comprising at least one page block including at least one page with a plurality of contiguous sectors;
at least one status indicator assigned to the at least one page block, the status indicator to indicate the status of data stored within the at least one page block; and
a sector count table maintained within a random access memory, the sector count table to store a number of the plurality of contiguous sectors that are filled with the data.

27. The apparatus of claim 26, wherein the at least one status indicator is configured to be read prior to storing the data in the at least one page block assigned to the status indicator.

28. The apparatus of claim 26, wherein the at least one status indicator is configured to be assigned to the at least one page of the at least one page block.

29. The apparatus of claim 26, wherein the at least one status indicator comprises a storage location capable of storing the state of at least one bit of the data stored within the plurality of contiguous sectors.

30. The apparatus of claim 26, wherein the at least one status indicator is configured to indicate validity status of the data stored in at least one sector of the plurality of contiguous sectors.

31. The apparatus of claim 26, wherein each of the plurality of contiguous sectors are selectively programmable, selectively erasable, and uniquely addressable.

32. The apparatus of claim 26, wherein the at least one page includes an upper page portion and a lower page portion, and wherein the memory device is configured to assign the at least one status indicator to at least the lower page portion.

33. The apparatus of claim 32, wherein the memory device is configured to transfer a second part of the data to the upper page portion after transferring a first part of the data to the lower page portion.

34. The apparatus of claim 26, wherein the memory device comprises a NAND flash memory.

35. A system, comprising:
a processor to issue a memory allocation request;
a display to display data processed by the processor;
a plurality of memory cells to be selected in response to receiving the memory allocation request, wherein the memory cells are organized to comprise at least one page block including at least one page comprising a plurality of contiguous sectors, each of the plurality of contiguous sectors being selectively programmable, selectively erasable, and uniquely addressable; and
a status indicator assigned to the at least one page block, the status indicator to indicate validity status of the data stored within the at least one page block.

36. The system of claim 35, wherein the plurality of memory cells comprise at least one of a single level cell structure or a multi-level cell structure.

37. The system of claim 35, wherein the plurality of memory cells comprise a NAND flash memory array.

38. The system of claim 35, comprising:
a lens; and
an imaging plane to couple to the processor, the imaging plane arranged to receive light captured by the lens.

39. The system of claim 35, comprising:
a cellular telephone transceiver to receive the data processed by the processor.

40. The system of claim 35, comprising:
a media player and a keypad control module to couple to the processor.

41. The system of claim 35, comprising:
a dynamic random access memory array to couple to the processor and to store a lookup table to contain information associated with the plurality of contiguous sectors.

42. A method of operating a memory system comprising:
receiving a data allocation request from a processor;
accessing a cache register to select an available memory cell of a plurality of memory cells in the memory system responsive to receiving the data allocation request, wherein the plurality of memory cells are organized as a plurality of blocks, each of the blocks comprising a group of sectors capable of storing a plurality of data bits;
assigning at least one page block from the plurality of blocks for memory storage, the at least one page block comprising at least one page; and
assigning at least one status indicator to the at least one page, the status indicator to indicate validity status of data stored within the at least one page.

43. The method of claim 42, wherein assigning at least one page block includes:
storing an address in at least one sector of the plurality of sectors to logically associate the at least one sector with the at least one page; and
storing the data within the at least one sector of the plurality of sectors associated with the at least one page.

44. The method of claim 42, wherein assigning at least one status indicator includes:
searching among the plurality of page blocks to identify a first page block having the status indicator indicating the data stored within the first page block is invalid; and
selecting the first page block to be used for storing the data.
